(19) United States
(12) Patent Application Publication
(10) Pub. No.: US 2026/0175832 A1
(43) Pub. Date: Jun. 25, 2026

(54) VEHICLE CONTROL METHOD AND VEHICLE CONTROL APPARATUS

(71) Applicant: Panasonic Automotive Systems Co., Ltd., Kanagawa (JP)

(72) Inventors: Toyoharu KURODA, Osaka Fu (JP); Hirofumi NISHIMURA, Kanagawa Ken (JP); Hisaya FUKUDA, Kanagawa Ken (JP)

(73) Assignee: Panasonic Automotive Systems Co., Ltd., Kanagawa (JP)

(21) Appl. No.: 19/399,044

(22) Filed: Nov. 24, 2025

(30) Foreign Application Priority Data
Dec. 19, 2024 (JP) 2024-223655

(51) Int. Cl. B60W 30/06; B60W 10/04; B60W 10/18; B60W 10/20; B60W 60/00

(52) U.S. Cl. CPC B60W 30/06; B60W 10/04; B60W 10/18; B60W 10/20; B60W 60/001; B60W 2420/403; B60W 2520/04; B60W 2540/12; B60W 2710/18; B60W 2710/20; B60W 2720/10; B60W 2720/24

(57) ABSTRACT

A vehicle control method is implemented by an vehicle control device provided on a vehicle. The method includes registering a teaching route including a first route and a second route. The first route is a route for forward traveling of the vehicle from a first position to a reversing point. The second route is a route for backward traveling of the vehicle from the reversing point to a planned parking position. When the vehicle performs forward traveling in response to operation on an operation device by an occupant of the vehicle, and the vehicle stops at a third position within a second distance from the reversing point, and the operation device receives a second operation different from the first operation, the vehicle is caused to autonomously perform backward traveling from the third position to the planned parking position based on the second route.

### CROSS-REFERENCE TO RELATED APPLICATIONS

This application is based upon and claims the benefit of priority from Japanese Patent Application No. 2024-223655, filed on Dec. 19, 2024, the entire contents of which are incorporated herein by reference.

### FIELD

Embodiments described herein relate generally to a vehicle control method and a vehicle control apparatus.

### BACKGROUND

Since residential parking spaces are often narrow, there is difficulty in parking of vehicles. Therefore, there is a high demand for parking in and leaving from a parking space by autonomous traveling.

A vehicle control apparatus serving to implement the above-noted type of autonomous traveling has been known (See, for example, patent literatures JP 2012-066709, JP 2022-069161, etc.).

Such a vehicle control apparatus registers in advance a teaching route to a planned parking position by a teaching travel.

Then, when parking a vehicle at the planned parking position, the vehicle is controlled to travel along the teaching route to park at the planned parking position.

However, in the conventional technology, assistance regarding parking based on the position of the vehicle and operation by an occupant has not been sufficiently provided, making it difficult to perform appropriate parking assistance.

### SUMMARY

A vehicle control method according to the present disclosure is implemented by a vehicle control apparatus provided in a vehicle. The vehicle includes an operation device to receive operation by an occupant and a traveling control device to control at least acceleration/deceleration and steering. The vehicle control method includes registering a teaching route including a first route and a second route. The first route is a route for forward traveling of the vehicle from a first position to a reversing point. The second route is a route for backward traveling of the vehicle from the reversing point to a planned parking position. The vehicle control method includes, in a case where the vehicle performs forward traveling in response to operation on the operation device by the occupant, and the vehicle is located at a second position within a first distance with respect to the first route, and the operation device receives a first operation, causing the traveling control device to autonomously perform forward traveling of the vehicle from the second position to the reversing point based on the first route, and thereafter causing the traveling control device to autonomously perform backward traveling of the vehicle from the reversing point to the planned parking position based on the second route. The vehicle control method includes, in a case where the vehicle performs forward traveling in response to operation on the operation device by the occupant, and the vehicle stops at a third position within a second distance from the reversing point, and the operation device receives a second operation different from the first operation, causing the traveling control device to autonomously perform backward traveling of the vehicle from the third position to the planned parking position based on the second route.

### BRIEF DESCRIPTION OF THE DRAWINGS

FIG. 1 is a block diagram illustrating an example of an overall configuration of a vehicle;

FIG. 2 is a diagram illustrated to describe an exemplary arrangement of a sensor and a camera;

FIG. 3 is a schematic diagram illustrating an exemplary exterior configuration of a vehicle;

FIG. 4 is a diagram illustrating an exemplary configuration near a driver's seat of a vehicle;

FIG. 5 is a diagram illustrated to describe an example of parking assistance;

FIG. 6 is a schematic diagram of an example of a data configuration of a route management DB;

FIG. 7A is a schematic diagram of an example of a display screen;

FIG. 7B is a schematic diagram of an example of a display screen;

FIG. 7C is a schematic diagram of an example of a display screen;

FIG. 8A is a schematic diagram of an example of a display screen;

FIG. 8B is a schematic diagram of an example of a display screen;

FIG. 9A is a schematic diagram of an example of a display screen;

FIG. 9B is a schematic diagram of an example of a display screen;

FIG. 9C is a schematic diagram of an example of a display screen;

FIG. 10 is a flowchart illustrating an example of the procedure of information processing executed by a control unit;

FIG. 11 is a flowchart illustrating an example of the procedure of information processing executed by a control unit;

FIG. 12 is a flowchart illustrating an example of the procedure of information processing executed by a control unit; and

FIG. 13 is a block diagram illustrating an exemplary hardware configuration of a vehicle control apparatus 10.

### DETAILED DESCRIPTION

Embodiments of a vehicle control method and a vehicle control apparatus according to the present disclosure will be described with reference to the drawings. Note that in the following description of the embodiments, the same reference numerals are assigned to the same parts, and redundant descriptions are omitted.

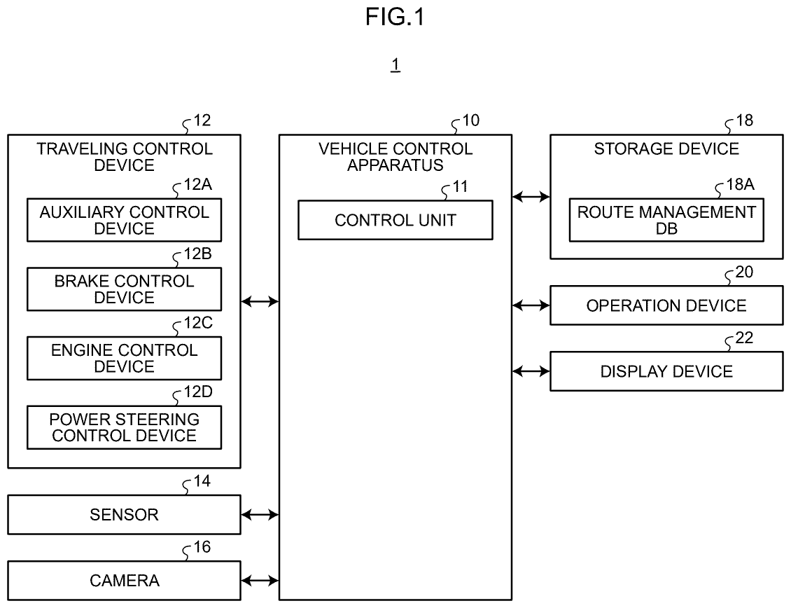

FIG. 1 is a block diagram illustrating an example of the overall configuration of a vehicle 1.

The vehicle 1 includes a vehicle control apparatus 10, a traveling control device 12, a sensor 14, a camera 16, a storage device 18, an operation device 20, and a display device 22.

The traveling control device 12, the sensor 14, the camera 16, the storage device 18, the operation device 20, and the display device 22 are connected to the vehicle control apparatus 10 so that data or signals can be transmittable and receivable therebetween. In other words, the vehicle control apparatus 10 is configured to be communicatively connected at least to the operation device 20, the camera 16, the display device 22, and the traveling control device 12.

The traveling control device 12 controls at least acceleration/deceleration and steering of the vehicle 1. The traveling control device 12 serves as a unit configured to implement the driving, braking, and turning motions used in traveling of the vehicle 1. For example, the traveling control device 12 includes a drive motor, a power transmission mechanism, a brake device, a steering device, or the like, as well as an electronic vehicle control apparatus that controls the components. The traveling control device 12 causes the vehicle 1 to travel by, for example, generating power with a drive motor and transmitting the power to wheels via a power transmission mechanism. Examples of the power transmission mechanism include a propeller shaft, a differential gear, a drive shaft, or the like.

The control of at least steering refers to the fact that the traveling control device 12 controls at least one of the driving, braking, and turning motions associated with traveling of the vehicle 1. Specifically, controlling steering refers to the fact that the traveling control device 12 controls at least one of a turning direction by steering operation, vehicle speed or acceleration via accelerator operation, and deceleration or stopping by brake operation. The controlling at least acceleration/deceleration refers to the fact that the traveling control device 12 controls at least one of the acceleration and deceleration of the vehicle 1.

The traveling control device 12 specifically includes an auxiliary control device 12A, a brake control device 12B, an engine control device 12C, and a power steering control device 12D. The brake control device 12B, the engine control device 12C, and the power steering control device 12D can be collectively referred to as an actuator control unit that controls the operation of the vehicle 1.

The auxiliary control device 12A is a control device that monitors the transmission state of the vehicle control apparatus 10 and executes appropriate degraded control as a backup in the case where the vehicle control apparatus 10 fails. Moreover, even in the case where the vehicle control apparatus 10 fails, if safety can be ensured by incorporating a degraded control function within the vehicle control apparatus 10, the separate degraded control may be unnecessary.

The brake control device 12B is a control device that performs brake control of the vehicle 1. The brake control may also be referred to as braking force control. For example, the brake control device 12B performs brake control of the vehicle 1 in accordance with enhancement and relaxation of operation on a brake pedal by an occupant. Specifically, the enhancement of the brake pedal operation by the occupant refers to the occupant depressing the brake pedal. In addition, the brake control device 12B performs brake control during autonomous traveling in response to a surrounding video.

The engine control device 12C is a control device that controls an engine that generates the driving force for the vehicle 1. The power steering control device 12D is a control device that controls the power steering of the vehicle 1.

The sensor 14 is mounted on the vehicle 1 and acquires at least an external situation of the vehicle 1. Specifically, the sensor 14 is various types of sensors that detect a traveling state of the vehicle 1 and an external situation of the vehicle 1. Examples of the sensor 14 include an accelerator opening sensor that detects accelerator opening, a steering-angle sensor that detects a steering angle of a steering device, an acceleration sensor that detects acceleration acting in a front-rear direction of the vehicle 1, a torque sensor that detects torque acting in a power transmission mechanism between a wheel of the vehicle 1 and a drive motor, a vehicle-speed sensor that detects the vehicle speed of the vehicle 1, a wheel-speed sensor, a global positioning system (GPS), and the like. The sensor 14 may also include a light detection and ranging (LiDAR), radar, an ultrasonic sensor, and the like. The sensor 14 outputs sensor information obtained by detection to the vehicle control apparatus 10.

The camera 16 is mounted on the vehicle 1 and serves as a surrounding sensor that monitors the environment surrounding the vehicle 1. The camera 16 includes an image sensor. In the present embodiment, the camera 16 captures an image of surroundings of the vehicle 1 and outputs the surrounding video data obtained by the capturing to the vehicle control apparatus 10. The surrounding video data is composed of pieces of image data captured in a time series around the vehicle 1. Hereinafter, the surrounding video data may be simply referred to as a surrounding video. Additionally, in the present embodiment, the camera 16 is also applicable to detection of an object existing around the vehicle 1 and estimation of a position of the vehicle 1 from a positional relationship between the vehicle 1 and the object existing around the vehicle 1.

The camera 16 is adjusted in position, number of installations, and capturing direction in advance so as to be capable of capturing the surroundings of the vehicle 1. For example, the vehicle 1 may be provided with four cameras 16 arranged to capture an image in four directions of front, rear, left, and right directions of the vehicle 1. Moreover, the number of cameras 16 provided on the vehicle 1 is not limited to four.

The storage device 18 stores various types of data. In the present embodiment, the storage device 18 stores a route management database (DB) 18A. Details of the route management DB 18A will be described later.

The storage device 18 is, for example, an auxiliary storage device such as a hard disk drive (HDD), solid-state drive (SSD), or flash memory. Moreover, at least part of the data included in the storage device 18 may be stored in an external storage device such as a server device, which is provided outside the vehicle 1 and communicatively connected to the vehicle control apparatus 10.

The operation device 20 receives operation by an occupant of the vehicle 1. The operation device 20 includes an operation mechanism related to a driving operation, such as a steering wheel, a shift lever for shifting gears in the transmission, an accelerator pedal, a brake pedal, a direction indicator lever, and a push switch, as well as an input device such as a keyboard, a touch panel, and a switch. The steering angle of a steering device is adjusted in response to an operation of a steering operation unit by the occupant. At least one of the keyboard, the touch panel, and the switch serves as an automatic parking instruction unit (or automatic parking instruction device) that receives an instruction to start automatic parking. The steering wheel is an example of the steering operation unit. In the present embodiment, autonomous parking and autonomous traveling may also be respectively referred to as automatic parking and automatic traveling for convenience of description.

The shift lever is an example of a forward/reverse operation unit (or forward/reverse operation device). The forward/reverse operation unit switches at least between forward and backward traveling of the vehicle 1. The brake pedal is an example of a brake operation unit (or brake operation device). The brake operation unit is an operation unit for operating a brake that suppresses the speed of the vehicle 1. In other words, the brake operation unit receives an instruction to decelerate the vehicle 1. The operation device 20 may constitute part of a human machine interface (HMI) or part of an in-vehicle infotainment (IVI).

The display device 22 is a display that outputs various types of images. The display device 22 is installed at a position where it can be visually recognized by an occupant of the vehicle 1. Examples of the display include a liquid-crystal display (LCD), an organic electro-luminescence (EL) display, or a projector. The display device 22 may also be a touch panel display integrally configured with the operation device 20. The display device 22 is an example of at least one of an HMI and an IVI.

Moreover, the display device 22 is not limited to being provided with only a single display area. For example, the display device 22 may include a plurality of display areas.

Further, the vehicle 1 may include a plurality of display devices 22. For example, the display device 22 may include a first display unit and a second display unit, which output various types of images. The first display unit and the second display unit are separate display devices 22. The first display unit and the second display unit may be disposed at different positions in the vehicle 1. For example, the first display unit may function as an IVI, and the second display unit may function as part of an instrument panel of the vehicle 1.

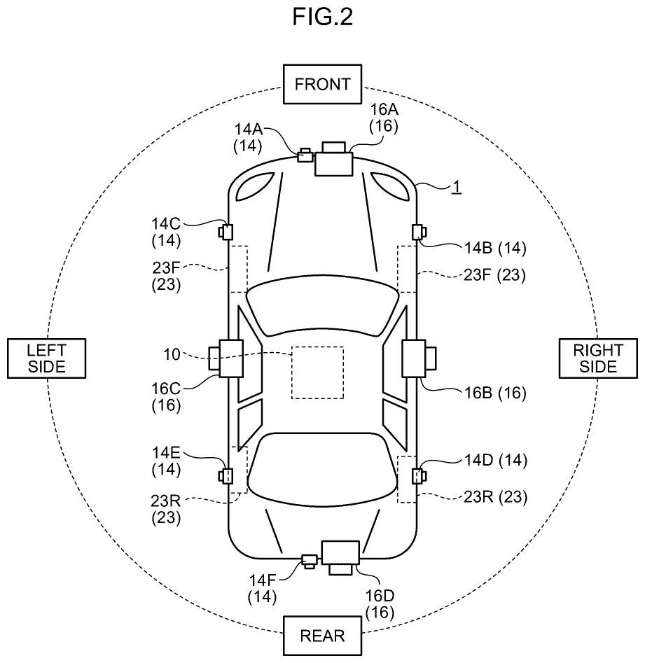

FIG. 2 is a diagram illustrated to describe an exemplary arrangement of the sensor 14 and the camera 16.

The vehicle 1 is provided with, for example, four cameras 16 (cameras 16A to 16D) so as to be capable of acquiring an external situation of the vehicle 1 in at least four directions of, for example, front, rear, right side, and left side of the vehicle 1.

Specifically, the cameras 16 include, for example, cameras 16A, 16B, 16C, and 16D. The camera 16A is disposed at a front part of the vehicle 1 and captures an image of the front of the vehicle 1. The camera 16A may be referred to as a front camera. The camera 16B is disposed at a right side part of the vehicle 1 and captures an image of the right side of the vehicle 1. The camera 16C is disposed at a left side part of the vehicle 1 and captures an image of the left side of the vehicle 1. The camera 16D is disposed at a rear part of the vehicle 1 and captures an image of the rear of the vehicle 1. The camera 16D may be referred to as a rear camera or a back camera.

The vehicle control apparatus 10 includes a control unit 11 that may use the surrounding video data captured particularly by the rear camera (the camera 16D) among the cameras 16 provided on the vehicle 1 for detection of a planned parking position, which will be described later. Details of the surrounding video data and the planned parking position will be described later.

Moreover, the number of cameras 16 provided on the vehicle 1 is not limited to four. Additionally, it is also preferable that sensors included in the sensor 14, such as LiDAR, radar, sonar, and ultrasonic sensors for detecting objects, be pre-adjusted in arrangement positions and numbers so as to be capable of acquiring external situations of the right side, left side, front, and rear of the vehicle 1. For example, as illustrated in FIG. 2, the sensor 14 includes sensors 14A to 14F. These sensors 14A to 14F are arranged in the vehicle 1 so as to be capable of acquiring external situations of the right side, left side, front, and rear of the vehicle 1. Moreover, the sensors 14 for detecting objects, such as LiDAR, radar, sonar, and ultrasonic sensors, may be disposed only in the rear part of the vehicle 1.

The configuration of the vehicle 1 will be described.

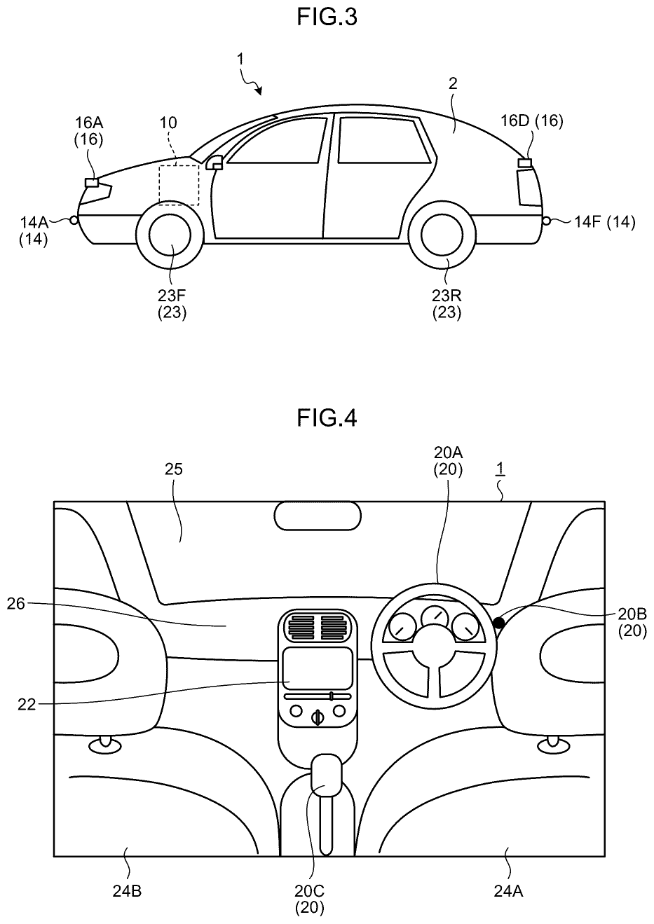

FIG. 3 is a schematic diagram illustrating an exemplary exterior configuration of the vehicle 1.

The vehicle 1 includes a vehicle body 2 and two pairs of wheels 23 arranged in a predetermined direction on the vehicle body 2. The two pairs of wheels 23 include a pair of front tires 23F and a pair of rear tires 23R (see also FIG. 2). Moreover, in FIGS. 2 and 3, a case where the vehicle 1 includes four wheels 23 is illustrated as an example. However, the number of the wheels 23 provided in the vehicle 1 is not limited to four.

The configuration near the driver's seat of the vehicle 1 in the present embodiment will be described.

FIG. 4 is a diagram illustrating an exemplary configuration near a driver's seat 24A of the vehicle 1 in the present embodiment.

The vehicle 1 includes the driver's seat 24A and a passenger seat 24B. In front of the driver's seat 24A, a windshield 25, a dashboard 26, a steering wheel 20A, an operation button 20B, and the display device 22 are provided. In addition, a shift lever 20C, which is a lever for shifting gears in the transmission, is provided near the driver's seat 24A.

The steering wheel 20A, the operation button 20B, and the shift lever 20C are examples of the operation device 20.

The steering wheel 20A is provided in front of the driver's seat 24A and is operable by an occupant. The rotation angle of the steering wheel 20A, that is, the steering angle, is electrically or mechanically linked to a change in a direction of the front tires 23F, which are the steerable wheels. Moreover, the steerable wheels may be the rear tires 23R, or both the front tires 23F and the rear tires 23R may be steerable wheels.

The operation button 20B is a button that can receive operation by the occupant. In addition, the operation button 20B may include a direction indicator. The location of the operation button 20B is not limited to the example illustrated in FIG. 4 and may, for example, be provided on the steering wheel 20A. Although one operation button 20B is illustrated in FIG. 4, a plurality of operation buttons 20B may be provided. In a case where the display device 22 also serves as a touch panel, the display device 22 may be an example of the operation device 20.

Referring back to FIG. 1, the description will be continued.

The vehicle control apparatus 10 is an electronic control unit that integrally controls respective components of the vehicle 1.

The vehicle control apparatus 10 controls the traveling control device 12 so that a traveling state of the vehicle 1 can become optimal, by using sensor information and surrounding video received respectively from the sensor 14 and the camera 16. In addition, the vehicle control apparatus 10 also controls the traveling control device 12 to cause the vehicle 1 to autonomously travel.

The vehicle control apparatus 10 includes the control unit 11. At least a part or the whole of the control unit 11 may be implemented as a software configuration achieved by cooperation of a processor and various programs stored in a memory. In addition, at least a part or the whole of the control unit 11 may also be implemented as a hardware configuration achieved by a dedicated circuit or the like.

The control unit 11 integrally controls respective components of the vehicle 1.

In the present embodiment, the control unit 11 executes information processing for parking assistance for the vehicle 1.

The control unit 11 integrally controls respective components of the vehicle 1.

In the present embodiment, the control unit 11 is configured to be able to switch a traveling mode between teaching traveling mode and autonomous traveling mode based on an input operation or the like on the operation device 20 by the occupant. Moreover, the traveling modes executable by the vehicle 1 may include various traveling modes other than teaching traveling mode and the autonomous traveling mode.

The teaching traveling mode is a mode for registering a teaching route to be used in a case of causing the vehicle 1 to autonomously travel. The teaching route is a route obtained by a teaching travel in which the vehicle 1 travels from a predetermined position to a target position such as a planned parking position. In the teaching traveling mode, the vehicle 1 is travel-controlled in response to operation by the occupant. In other words, in the teaching traveling mode, the control unit 11 receives an operation, which is a driving operation by the occupant, via the operation device 20 and controls the traveling control device 12 such that the vehicle 1 travels in accordance with the operation. In other words, during the teaching travel in which the vehicle 1 travels from the predetermined position to the target position in response to the operation of the occupant in the teaching traveling mode, the control unit 11 registers the teaching route based on surrounding video acquired by the camera 16, and the like.

The autonomous traveling mode is a mode for causing the vehicle 1 to autonomously travel. In the present embodiment, the autonomous traveling mode refers to a mode for causing the vehicle 1 to autonomously travel along a teaching route. In the autonomous traveling mode, the control unit 11 controls at least steering and controls the traveling control device 12 such that the vehicle travels along the teaching route. In the autonomous traveling mode, the vehicle 1 is automatically travel-controlled by the vehicle control apparatus 10 without a manual operation by the occupant. In other words, in the autonomous traveling mode, the control unit 11 causes the vehicle 1 to autonomously travel from a predetermined position to a target position by controlling at least the steering on the basis of the teaching route and surrounding video acquired by the camera 16, sensor information, and the like. In the present embodiment, the autonomous traveling may be referred to as automatic parking, and the autonomous traveling mode may be referred to as automatic parking mode.

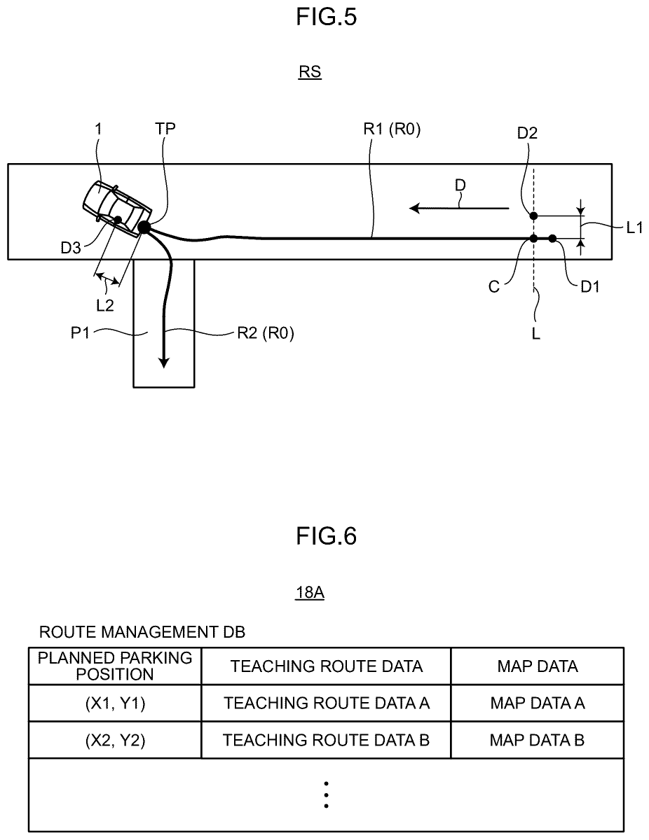

FIG. 5 is a diagram illustrated to describe an example of parking assistance in the present embodiment.

For example, in the teaching traveling mode, the description assumes a configuration in which the vehicle 1 is caused to travel forward by the operation of the occupant until at least part of the vehicle body 2 of the vehicle 1 passes through at least part of the region of the parking space including a planned parking position P1, and then the vehicle 1 is stopped by the operation of the occupant, and the vehicle 1 is reversed from the stopping position, which is a reversing point TP, to be parked at the planned parking position P1.

In other words, in the teaching traveling mode for entry to the planned parking position P1, the teaching travel from a first position D1 to the planned parking position P1 is performed by a manual operation on the operation device 20 by the occupant.

The first position D1 is an optional position designated by the occupant in a real space RS. The planned parking position P1 is a position at which the vehicle 1 is planned to be parked. The planned parking position P1 may be, for example, a parking lot, but is not limited thereto. In addition, the planned parking position P1 may be any planned parking position selected by the occupant in the real space RS.

In the present embodiment, a teaching route R0 includes a first route R1 and a second route R2. The first route R1 is a route from the first position D1 at which the teaching travel is started to the reversing point TP by forward traveling of the vehicle 1. Thus, the first position D1 is a position on the first route R1 and constitutes part of the first route R1. The second route R2 is a route for backward traveling from the reversing point TP to the planned parking position P1. The reversing point TP is the stopping position where, after the vehicle 1 travels forward along the first route R1 and stops, a turn-back steering is performed at the stopping position and the traveling direction is switched to backward traveling to head toward the planned parking position P1 for parking at the planned parking position P1.

In the teaching travel for entry to the planned parking position P1, for example, the occupant operates the operation device 20 to travel forward from the first position D1 toward the reversing point TP and then operates the operation device 20 to steer the vehicle 1 to travel backward from the reversing point TP toward the planned parking position P1. The control unit 11 generates teaching route data of the teaching route R0 including the first route R1 and the second route R2 by the teaching travel, and registers the teaching route data in the route management DB 18A of the storage device 18. Details of the route management DB 18A will be described later.

The control by the control unit 11 during the teaching traveling mode is described in detail below.

The control unit 11, in response to determining a start of the teaching traveling mode, switches a traveling mode to the teaching traveling mode. Then, in the teaching traveling mode, the control unit 11 executes the following processing.

The control unit 11 acquires sensor information from the sensor 14 indicating a traveling state of the vehicle 1. Then, the control unit 11 estimates a current position of the vehicle 1 on the basis of the temporal changes in the sensor values represented by the sensor information. For example, on the basis of the temporal changes in a vehicle speed and a yaw rate represented by the sensor values, the control unit 11 calculates an amount of movement of the vehicle 1 from a reference position such as a travel start position at the time the teaching traveling mode was initiated, and estimates the current position of the vehicle 1 on the basis of the amount of movement.

Moreover, the estimation accuracy of the current position based on the amount of movement may be low. For this reason, the control unit 11 may use, as the current position, a result of correcting the estimated current position on the basis of surrounding video of the vehicle 1 acquired by the camera 16. The control unit 11 may also use, as the current position of the vehicle 1, position information obtained by a GPS installed in the vehicle 1.

The control unit 11 sequentially stores, in the storage device 18, the current positions of the vehicle 1 sequentially estimated along traveling of the vehicle 1. Specifically, the control unit 11 recognizes, as the teaching route R0, a traveling route during the teaching travel that is represented by a group of current positions sequentially estimated during a period from a reception time of an instruction to start the teaching traveling mode (the first position D1) until a reception time of an instruction to end the teaching mode, and stores, in the storage device 18, teaching route data representing the teaching route R0. In addition, the control unit 11 stores map data in the storage device 18.

The teaching route data is composed of a group of pieces of traveling information for respective positions that are the current positions sequentially estimated during the teaching travel. The traveling information includes an INDEX, a traveling position, an azimuth, a traveling direction, and reference traveling information. The INDEX is identification information of the traveling information. The traveling position is the estimated position of the vehicle 1. The azimuth indicates the orientation of the vehicle 1 at the position. The traveling direction indicates the direction of travel of the vehicle 1 at the position and is represented by, for example, forward or reverse. The reference traveling information is information indicating a travel state at the position. The reference traveling information includes, for example, information such as a steering angle detected at each position during the teaching traveling, a vehicle speed, and an external situation acquired by the sensor 14.

Further, during the teaching traveling of the vehicle 1, the control unit 11 creates map data for estimating the current position of the vehicle 1 from the surrounding video captured by the camera 16. Techniques such as a simultaneous localization and mapping (SLAM) are used for estimating the current position of the vehicle 1 from the surrounding video.

The map data refers to map data in which first feature points around the vehicle 1 have been registered during traveling of the vehicle 1 along the teaching route R0.

The first feature point is a feature point obtained by analyzing the surrounding video acquired by the camera 16 during the teaching traveling. In other words, in the present embodiment, a feature point that is specified according to the surrounding video during the teaching traveling is referred to as a first feature point.

For example, a feature point is a part, in an object included in the real space RS (e.g., a tree, a wall, or a pillar), at which a characteristic image pattern is obtained by analysis of the surrounding video. The part mentioned above is, for example, an edge part of the object mentioned above. As described above, in the present embodiment, the feature point specified during the teaching traveling is referred to as the first feature point. For this reason, the map data includes a plurality of first feature points, and each first feature point is registered so as to be identifiable for each first feature point by assigning an identification number.

The feature point is represented by feature-point data including a three-dimensional position and a feature descriptor. The three-dimensional position of the feature point is a three-dimensional position of the feature point in the real space and is represented, for example, by a three-dimensional orthogonal coordinate system (X, Y, Z).

The feature descriptor of the feature point is a characteristic quantity obtained by image analysis of image frames constituting the captured video. The feature descriptors of the first feature points include, for example, luminance or on the video, feature descriptors of scale invariant feature transform (SIFT) and speeded up robust features (SURF), or the like.

In the map data, one first feature point is registered for each identical three-dimensional position. Moreover, for the same three-dimensional position, a plurality of first feature points may be registered for each capturing position and capturing direction by the camera 16 at the three-dimensional position. Moreover, the feature-point data of the first feature points registered in the map data may further include image data of the object having the first feature point.

During the teaching traveling, the control unit 11 estimates coordinates of the first feature points in the real space RS by using, for example, stereo photogrammetry from the surrounding video. Specifically, the control unit 11 reads captured images taken at different timings that constitute the surrounding video and associates the same first feature point appearing commonly in the captured images. Then, the control unit 11, for example, estimates a tentative position of the vehicle 1 at the time the captured images are captured and determines the tentative coordinates of the first feature point in the real space RS by using a principle of triangulation. Then, the control unit 11 performs bundle adjustment by using, for example, the tentative position of the vehicle 1 and the tentative coordinates of the first feature point in the real space RS as reference information, to calculate a formal position of the vehicle 1 and the formal coordinates of the first feature point in the real space RS so as to minimize the re-projection error when each first feature point in the real space RS is projected onto all the captured images. The control unit 11 then stores, in the storage device 18, the map data in which the first feature points are registered, the map data being represented by feature-point data including the formal coordinates as three-dimensional positions of the first feature points in the real space RS.

The three-dimensional positions of the first feature points registered in the map data may be positions measured in advance by using a light detection and ranging (LiDAR) or a stereo camera, without employing a SLAM technique. However, from a viewpoint of suppressing a decrease in position estimation accuracy, it is recommended to employ the SLAM technique.

The control unit 11 executes the processing mentioned above in the teaching traveling mode. For this reason, in the teaching traveling mode, the control unit 11 registers the teaching route data of the teaching route R0 and the map data on the basis of the surrounding video acquired by the camera 16 during the teaching travel. In other words, the control unit 11 generates, on the basis of the surrounding video, the teaching route data of the teaching route R0 obtained by the teaching travel and the map data in which three-dimensional positions of the first feature points around the vehicle 1 during traveling along the teaching route R0 and feature descriptors of the first feature points are registered, and stores the teaching route data and the map data in the route management DB 18A of the storage device 18 in association with each other.

Thus, in the route management DB 18A of the storage device 18, for each teaching travel, the teaching route data of the teaching route R0 composed of the group of pieces of traveling information for respective positions that are the current positions sequentially estimated during the teaching travel and the map data in which the first feature points observed at the respective positions are registered are registered in association with each other.

FIG. 6 is a schematic diagram of an example of the data configuration of the route management DB 18A. The route management DB 18A is a database for registering the teaching route data and the map data for each teaching route. Moreover, a data format of the route management DB 18A is not limited to a database.

For example, a case will be described in which the vehicle 1 performs a teaching travel from the first position D1 to the planned parking position P1 via the reversing point TP. In this case, the control unit 11 registers, in the route management DB 18A, the teaching route data of the teaching route R0 including the first route R1 for forward traveling from the first position D1 to the reversing point TP and the second route R2 for backward traveling from the reversing point TP to the planned parking position P1, the map data generated during the teaching travel of the teaching route R0, and the position information of the planned parking position P1, in association with one another.

Any information representing the parking area for the vehicle 1 represented by the planned parking position P1 may be used as the position information of the planned parking position P1. The position information of the planned parking position P1 is represented, for example, by position coordinates of a specific single point in the parking area represented by the planned parking position P1, or by a group of position coordinates representing positions in the parking area. In the present embodiment, as an example, the position information of the planned parking position P1 is described as a group of position coordinates representing the position in the parking area represented by the planned parking position P1.

Moreover, the control unit 11 may assign identification information for uniquely identifying the map data and register the identification information in the route management DB 18A. As described above, the teaching route data is composed of the group of pieces of traveling information for respective positions that are the current positions sequentially estimated during the teaching travel. The traveling information includes an external situation acquired by at least one of the sensor 14 and the camera 16 at each position during the teaching travel. Thus, the teaching route data of the teaching route R0 may include an external situation acquired by the sensor 14.

In the autonomous traveling mode, the control unit 11 controls at least steering along the teaching route R0 obtained by the teaching travel and, on the basis of the teaching route R0 and surrounding video captured by the camera 16 and the like, causes the vehicle 1 to autonomously travel. Moreover, in the autonomous traveling mode, the control unit 11 executes steering control and acceleration/deceleration control of forward/rear of the vehicle 1; however, at least part of the acceleration/deceleration control of forward/rear may be executed by operation by the driver.

The control performed by the control unit 11 in the present embodiment will be described in detail.

The control unit 11 displays, on the display device 22 of the vehicle 1 during traveling, a button image used for instructing the start of parking registration.

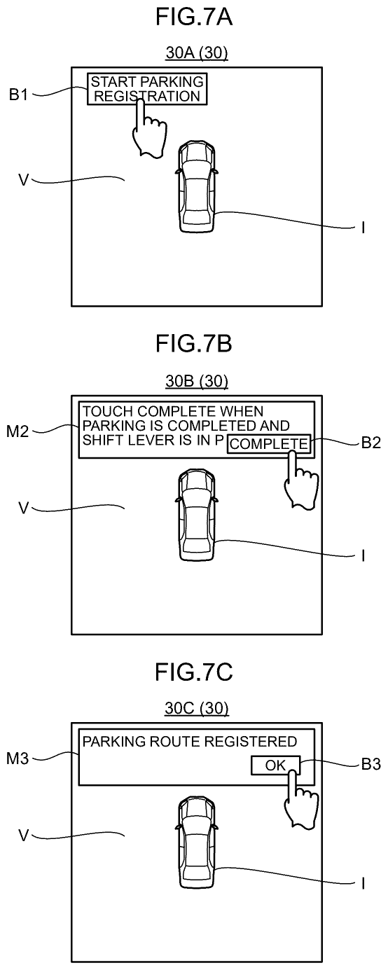

FIG. 7A is a schematic diagram of an example of a display screen 30A. The display screen 30A is an example of a display screen 30 displayed on the display device 22.

The control unit 11 causes the display device 22 of the vehicle 1 during traveling to display the display screen 30A including a button image B1 for instructing the start of parking registration. The display screen 30A includes, for example, a surrounding video V captured by the camera 16. The control unit 11 may further superimpose and display an icon image I representing the vehicle 1 at a relative position corresponding to the current position of the vehicle 1 in the surrounding video V. The control unit 11 displays the button image for instructing the start of parking registration by superimposing and displaying the button image B1 on the surrounding video V. Moreover, in the case where power is supplied to each component of the vehicle 1, the control unit 11 may cause the display device 22 to display the surrounding video V and continue the display of the surrounding video V. Then, as appropriate to the circumstances, the control unit 11 may superimpose and display, on the surrounding video V, the button image B1, various other displays (described later), or the like.

Referring back to FIG. 5, the description will be continued.

The control unit 11 acquires current position information of the vehicle 1. Then, the control unit 11 determines whether teaching route data corresponding to the current position of the vehicle 1 is already registered in the route management DB 18A. Specifically, the control unit 11 determines whether teaching route data for entry to the planned parking position P1 corresponding to the current position information of the vehicle 1 is registered in the route management DB 18A.

For example, the control unit 11 identifies one or more available parking positions from the current position of the vehicle 1 by a known method. Then, the control unit 11 determines whether teaching route data corresponding to the planned parking position P1 that matches the identified available parking position or includes the available parking position is registered in the route management DB 18A. This determination processing allows the control unit 11 to determine whether teaching route data for entry to the planned parking position P1 corresponding to the current position information of the vehicle 1 is registered in the route management DB 18A.

In response to determining that teaching route data corresponding to the current position of the vehicle 1 is not registered, the control unit 11 determines, upon a stop of the vehicle 1, whether an instruction to start parking registration is received. Specifically, the control unit 11 determines that the vehicle 1 is stopped when the speed included in the sensor information obtained by the sensor 14 becomes zero. Then, when the display region of the button image B1 on the display screen 30A illustrated in FIG. 7A is operated, the control unit 11 determines that the instruction to start parking registration is received. When the control unit 11 determines that the vehicle 1 is stopped by analyzing sensor information or the like and also determines that the instruction to start parking registration is received, the control unit 11 switches the traveling mode to the teaching traveling mode.

Referring back to FIG. 5, the description will be continued.

Then, the teaching travel of the vehicle 1 is started by a driving operation of the vehicle 1 by the occupant. In the present embodiment, a driving operation by the occupant causes the vehicle 1 to travel forward (in the direction of arrow D in FIG. 5) from the first position D1 to the reversing point TP, and then causes the vehicle 1 to travel backward from the reversing point TP to the planned parking position P1, thereby performing the teaching travel. When the teaching travel is started, the control unit 11 sequentially stores the map data and the current positions of the vehicle 1 in the storage device 18. Specifically, the control unit 11 sequentially stores the current positions of the vehicle 1 sequentially estimated along the teaching travel of the vehicle 1. At this event, the control unit 11 assigns an INDEX to the current position and sequentially stores, in association with the INDEX, the traveling position, orientation, traveling direction, and reference traveling information. The control unit 11 also determines first feature points by performing image analysis on the surrounding video V captured by the camera 16 during the teaching travel and sequentially registers the first feature points in the map data.

Then, the control unit 11 determines whether the vehicle 1 is stopped and an instruction to complete the teaching travel is received. For example, the control unit 11 causes the display device 22 to display information representing an operation for instructing completion of the teaching travel.

FIG. 7B is a schematic diagram of an example of a display screen 30B. The display screen 30B is an example of the display screen 30 displayed on the display device 22.

The control unit 11 causes the display device 22 to display the display screen 30B that includes an indication M2 representing an operation for instructing completion of the teaching travel and a button image B2 for the occupant to operate to instruct completion of the teaching travel. Similar to the above, the display screen 30B may also include the surrounding video V and the icon image I of the vehicle 1. The indication M2 is information representing an operation for instructing completion of the teaching travel.

In FIG. 7B, as an example, a case is illustrated in which the operation for instructing completion of the teaching travel represents an operation of putting the shift lever into P (parking) after completion of parking or a button operation for switching a shift of the vehicle 1 to parking, and an operation of the button image B2. The operation of putting the shift lever into P (parking) or the button operation for switching the shift of the vehicle 1 to parking is an example of a parking switching operation.

Further, in FIG. 7B, as an example, a case is illustrated in which the indication M2 is a wording representing an operation for instructing completion of the teaching travel. Moreover, the indication M2 may be a still image, an animation image, an icon, or the like representing an operation for instructing completion of the teaching travel and is not limited to wording.

In response to determining reception of a stop of the vehicle 1 and the operation for instructing completion of the teaching travel by the occupant's operation of the operation device 20, the control unit 11 recognizes, as the teaching route R0, a traveling route R during the teaching travel represented by the group of current positions sequentially estimated during the teaching travel, and registers, in the route management DB 18A in association with one another, teaching route data representing the teaching route R0, the map data in which the first feature points specified during the teaching travel are registered, and position information of the planned parking position P1 representing the current position of the stopped vehicle 1.

Referring back to FIG. 5, the description will be continued.

In the present embodiment, the teaching route data of the teaching route R0, which includes the first route R1 for forward traveling from the first position D1 to the reversing point TP (the direction of arrow D) and the second route R2 for backward traveling from the reversing point TP to the planned parking position P1, is registered in the route management DB 18A.

Then, the control unit 11 causes the display device 22 to display information indicating that the teaching route R0 is registered.

FIG. 7C is a schematic diagram of an example of a display screen 30C. The display screen 30C is an example of the display screen 30 displayed on the display device 22.

The control unit 11 causes the display device 22 to display the display screen 30C including an indication M3 indicating that the teaching route R0 is registered and a button image B3 for receiving a confirmation operation from the occupant. Similar to the foregoing, the display screen 30C may also include the surrounding video V and the icon image I of the vehicle 1. The indication M3 is information indicating that the teaching route R0 is registered. In FIG. 7C, as an example, the indication M3 is illustrated as wording indicating that the teaching route R0 is registered. Moreover, the indication M3 may be a still image, an animation image, an icon, or the like indicating that the teaching route R0 is registered, and is not limited to wording.

As a result of the foregoing processing, in the route management DB 18A, there are registered in association with one another: the teaching route data of the teaching route R0 including the first route R1 for forward traveling from the first position D1 to the reversing point TP and the second route R2 for backward traveling from the reversing point TP to the planned parking position P1, the map data, and the planned parking position P1.

Referring back to FIG. 5, the description will be continued.

The processing by the control unit 11 is now described in a case where at least part of the teaching route R0 is caused to be autonomously traveled by the vehicle 1.

For example, a case is considered, in which the vehicle 1 performs forward traveling in response to an operation of the occupant on the operation device 20, the vehicle 1 is located at a second position D2 within a first distance L1 with respect to the first route R1, and the operation device 20 receives a first operation. Being within the first distance L1 with respect to the first route R1 means that a distance to the first route R1 is equal to or less than the first distance L1.

The first operation is an operation in which an automatic parking instruction unit receives an instruction to start automatic parking. The first operation may alternatively be an operation in which a brake operation unit receives enhancement in braking by the occupant, causing the vehicle 1 to stop, and the automatic parking instruction unit receives an instruction to start automatic parking.

As described above, at least one of a keyboard, a touch panel, and a switch included in the operation device 20 serves as the automatic parking instruction unit (or automatic parking instruction device) that receives an instruction to start automatic parking.

The second position D2 is the position of the vehicle 1 in the real space RS when the vehicle 1 performs forward traveling by an operation of the occupant on the operation device 20 and the first operation is received. Alternatively, the second position D2 may be a position of the vehicle 1 in the real space RS when, after the vehicle 1 performs forward traveling in response to an operation of the occupant on the operation device 20, the vehicle 1 further performs forward traveling in response to an operation of the occupant on the operation device 20, a brake operation unit receives enhancement in braking force by the occupant to stop the vehicle 1, and the automatic parking instruction unit receives an instruction to start automatic parking.

Specifically, the second position D2 is a position within the first distance L1 with respect to the first route R1. The first distance L1 may be set to any value, so long as it is predetermined.

The first distance L1 of the second position D2 with respect to the first route R1 is the length, on a straight line L passing through the second position D2 and orthogonal to the first route R1, between the orthogonal intersection C of the straight line L with the first route R1 and the second position D2.

The first distance L1 may be set to any value, so long as it is predetermined in advance. For example, the first distance L1 may be set to any position from which the vehicle 1 located at the second position D2 can gradually approach the first route R1 in the course of forward traveling and can travel on the first route R1 along the first route R1. The first distance L1 may be, for example, the same distance as a second distance L2 described later.

In a case where the vehicle 1 performs forward traveling (in the direction of arrow D in FIG. 5) in response to an operation of the occupant on the operation device 20, if the second position D2 is within the first distance L1 with respect to the first position D1 that is a part of the first route R1 and the operation device 20 receives the first operation, the control unit 11 causes the traveling control device 12 to autonomously perform forward traveling of the vehicle 1 from the second position D2 to the reversing point TP on the basis of the first route R1. Thereafter, the control unit 11, on the basis of the second route R2 included in the teaching route R0 including the first route R1, causes the traveling control device 12 to autonomously perform backward traveling of the vehicle 1 from the reversing point TP to the planned parking position P1, thereby parking the vehicle 1 at the planned parking position P1.

In other words, it is considered that, in the autonomous traveling mode, the vehicle 1 performs forward traveling (in the direction of arrow D) in response to an operation of the occupant on the operation device 20, the vehicle 1 is located at the second position D2 within a second distance L2 from the first position D1 that is a part of the first route R1, and the operation device 20 receives the first operation. In this case, the control unit 11 causes the vehicle 1 to autonomously perform forward traveling along the identified teaching route R0 from the second position D2 to the reversing point TP on the basis of the first route R1 included in the teaching route R0, and thereafter causes the vehicle 1 to autonomously perform backward traveling from the reversing point TP to the planned parking position P1 on the basis of the second route R2 included in the teaching route R0.

Further, for example, a situation is considered in which the vehicle 1 performs forward traveling in response to an operation of the occupant on the operation device 20 and the vehicle 1 is stopped at a third position D3 that is within a second distance L2 from the reversing point TP. Specifically, for example, after switching to the autonomous traveling mode, the vehicle 1 performs forward traveling in response to an operation (driving operation by the occupant) of the occupant on the operation device 20, passes the reversing point TP, stops at the third position D3 that is a position within the second distance L2 from the reversing point TP, and a second operation is received.

The second operation is an operation different from the above-described first operation. More specifically, the second operation is an operation in which a forward/reverse operation unit receives an instruction to perform backward traveling from the occupant and a brake operation unit receives relaxation of braking from the occupant. Specifically, the second operation is an operation in which, by an operation of a shift lever included in the operation device 20 by the occupant, the shift is changed to reverse to receive an instruction to perform backward traveling, and the brake operation unit receives relaxation of braking by the occupant.

The third position D3 is a position of the vehicle 1, within the second distance L2 from the reversing point TP, when the vehicle 1 performs forward traveling in response to an operation of the occupant on the operation device 20 and stops. Being within the second distance L2 from the reversing point TP means that a distance to the reversing point TP is equal to or less than the second distance L2.

The second distance L2 may be set to any value, so long as it is predetermined in advance. More specifically, the second distance L2 may be set to any value equal to or less than a maximum distance, in the real space RS, from the reversing point TP (which is a position on the first route R1) at which the vehicle 1 can be parked in a single stroke by autonomously performing backward traveling to the planned parking position P1 represented by the teaching route R0 including the first route R1. The “parking in a single stroke by autonomous traveling” means autonomously parking by backward traveling only, without performing any turn-back steering of the vehicle 1, from the stopping position to the planned parking position P1. The control unit 11 may make the determination mentioned above by a known method based on the surrounding video V. As described above, the second distance L2 may be the same distance as the first distance L1.

In a case where the vehicle 1 performs forward traveling (in the direction of arrow D in FIG. 5) in response to an operation of the occupant on the operation device 20, the vehicle 1 stops at the third position D3 that is a position within the second distance L2 from the reversing point TP, and the second operation is received, the control unit 11 causes the traveling control device 12 to autonomously perform backward traveling of the vehicle 1 from the third position D3 to the planned parking position P1 on the basis of the second route R2 from the reversing point TP to the planned parking position P1, thereby parking the vehicle 1.

Further, in a case where the vehicle 1 performs forward traveling (in the direction of arrow D) in response to an operation of the occupant on the operation device 20, the vehicle 1 stops in a predetermined orientation at the third position D3 that is a position within the second distance L2 from the reversing point TP, and the operation device 20 receives the second operation, the control unit 11 may cause the vehicle 1 to autonomously perform backward traveling from the third position D3 to the planned parking position P1.

The predetermined orientation refers to an attitude and an inclination of the vehicle 1. The predetermined orientation may be any orientation that allows the vehicle 1 stopped at the third position D3 to autonomously travel by backward traveling from the third position D3 to the planned parking position P1.

The control during the autonomous travel mode will be described in further detail.

In a case where teaching route data corresponding to the current position of the vehicle 1 is registered in the route management DB 18A, the control unit 11 switches the traveling mode to the autonomous travel mode. Then, the control unit 11 reads, from the route management DB 18A, map data corresponding to the position information of the planned parking position P1 identified for the current position.

Then, the control unit 11 estimates the self-position, which is the current position of the vehicle 1, on the basis of the read map data and the surrounding video V of the vehicle 1 acquired by at least one camera 16.

For example, the control unit 11 matches second feature points identified from the surrounding video V captured by the camera 16 with first feature points stored in the map data by performing pattern matching, feature-descriptor search, or the like.

The second feature points are feature points obtained by analyzing the surrounding video V captured by the camera 16 after switching to the autonomous traveling mode. The control unit 11 may identify the second feature points by using a method similar to the method for identifying the first feature points during the teaching traveling.

The control unit 11 randomly selects several (e.g., three to six) second feature points among the identified second feature points that can be matched with the first feature points stored in the map data.

Then, the control unit 11 estimates the current position of the vehicle 1 in real space on the basis of the positions of these several second feature points in the surrounding video V and the three-dimensional positions in the real space of the first feature points registered in the map data corresponding to these several second feature points. In this case, the control unit 11 estimates the current position of the vehicle 1 by solving a PnP problem through a known technique such as Lambda Twist (e.g., the literature: Mikael Persson et al., “Lambda Twist: An Accurate Fast Robust Perspective Three-Point (P3P) Solver”, ECCV 2018, pp. 334-349, published in 2018, available at http://openaccess.thecvf.com/content_ECCV_2018/papers/Mikael_Persson_Lambda_T wist_An_ECCV_2018_paper. pdf).

Through the foregoing processing, the control unit 11 estimates current position information representing the current position of the vehicle 1 on the basis of the map data and the surrounding video V of the vehicle 1 acquired by at least one camera 16, the current position information including a two-dimensional position (X coordinate and Y coordinate) of the vehicle 1 in the real space and information relating to an attitude, which is an orientation of the vehicle 1.

Then, in the case where the vehicle 1 stops such that its stopping position is the second position D2 within the first distance L1 with respect to the first route R1, and a first operation such as reception of an instruction to start automatic parking is received, the control unit 11 performs traveling control along the teaching route R0. The occupant issues an operation instruction by operating at least one of a predetermined key, a display region, a display button, and a switch for receiving the instruction to start automatic parking. Upon reception of this operation instruction, the control unit 11 receives the instruction to start automatic parking.

In other words, in this case, the control unit 11 causes the traveling control device 12 to autonomously perform forward traveling of the vehicle 1 from the second position D2 to the reversing point TP on the basis of the first route R1 included in the teaching route R0. Then, the control unit 11 causes the traveling control device 12 to autonomously perform backward traveling of the vehicle control apparatus 10 from the reversing point TP to the planned parking position P1 on the basis of the second route R2 included in the teaching route R0.

On the other hand, when the vehicle 1 stops and a reverse instruction is received, for example by shifting a shift of the vehicle 1 to reverse (R), the control unit 11 determines whether the stopping position of the vehicle 1 is a position at which entry to the planned parking position P1 is permissible.

The control unit 11 may determine whether the stopping position of the vehicle 1 is a position at which entry to the planned parking position P1 is permissible by determining whether the vehicle 1 can be parked at the planned parking position P1 in a single stroke by autonomously performing backward traveling from the stopping position. More specifically, the control unit 11 determines whether the stopping position of the vehicle 1 is a position at which entry to the planned parking position P1 is permissible by determining whether a distance between the stopping position and the reversing point TP is equal to or less than the second distance L2. The reversing point TP is represented by an intersection between the first route R1 and the second route R2 included in the teaching route R0. The control unit 11 may make this determination by a known technique on the basis of the surrounding video V, sensor information, and the like.

For example, consider a case where the vehicle 1 stops at a position that is downstream, in the traveling direction along the first route R1 (in the direction of arrow D in FIG. 5), of the first position D1 and upstream, in the same traveling direction (i.e., on the side of the first position D1), of the reversing point TP of the first route R1. In addition, consider that the stopping position is at a distance greater than the second distance L2 from the reversing point TP. In this case, the control unit 11 determines that the stopping position of the vehicle 1 is a position at which entry to the planned parking position P1 is not permissible.

Further, consider a scenario in which the vehicle 1, perform forward traveling under driving by the occupant along the first route R1, passes the reversing point TP and then stops after perform forward traveling a distance greater than the second distance L2 from the reversing point TP of the first route R1. In this case as well, the control unit 11 determines that the stopping position of the vehicle 1 is a position at which entry to the planned parking position P1 is not permissible.

In response to determining that the entry is not permissible, the control unit 11 causes the display device 22 to display an instruction to correct the position to an entry-permissible position for the planned parking position P1.

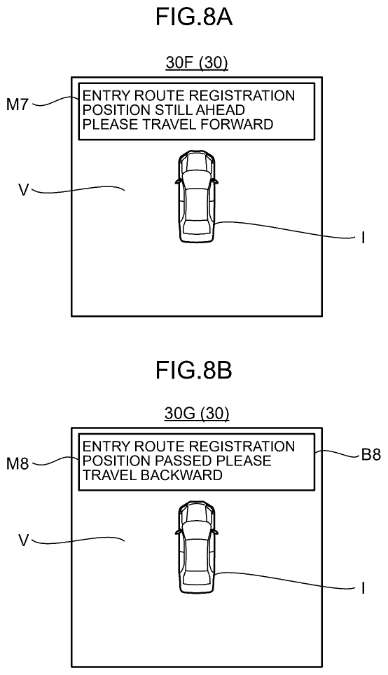

FIG. 8A is a schematic diagram of an example of a display screen 30F. The display screen 30F is an example of the display screen 30 displayed on the display device 22.

In the autonomous traveling mode, in a case where the vehicle 1 stops, by driving operation of the occupant, at a position located, toward the first position D1, apart from the reversing point TP of the first route R1 by at least the second distance L2, and a reverse instruction is received, for example by shifting a shift of the vehicle 1 to reverse (R), the control unit 11 causes, for example, the display device 22 to display the display screen 30F.

The display screen 30F is the display screen 30 in which an indication M7 prompting forward traveling because the reversing point TP is still ahead and the icon image I of the vehicle 1 are superimposed on the surrounding video V. The indication M7 is an example of position-correction instruction information for an entry-permissible position. In FIG. 8A, as an example, the indication M7 is illustrated as wording prompting forward traveling because the reversing point TP is still ahead. Moreover, the indication M7 may be a still image, an animation image, an icon, or the like that represents prompting forward traveling because the reversing point TP is still ahead, and is not limited to wording.

FIG. 8B is a schematic diagram of an example of a display screen 30G. The display screen 30G is an example of the display screen 30 displayed on the display device 22.

In the autonomous traveling mode, in a case where the vehicle 1 stops, by driving operation of the occupant, at a position located, away from the first position D1, downstream of the reversing point TP of the first route R1 by a distance greater than the second distance L2, and a reverse instruction is received, for example by shifting the transmission of the vehicle 1 to reverse (R), the control unit 11 causes, for example, the display device 22 to display the display screen 30G.

The display screen 30G is the display screen 30 in which an indication M8 prompting backward traveling because the reversing point TP is passed and the icon image I of the vehicle 1 are superimposed on the surrounding video V. The indication M8 is an example of position-correction instruction information for an entry-permissible position. In FIG. 8B, as an example, the indication M8 is illustrated as wording prompting backward traveling because the reversing point TP is passed. Moreover, the indication M8 may be a still image, an animation image, an icon, or the like that represents prompting backward traveling because the reversing point TP is passed, and is not limited to wording.

The control unit 11, after causing the display device 22 to display the display screen 30F or the display screen 30G, upon driving is started in response to an operation on the operation device 20 by the occupant, may resume estimation of the self-position on the basis of the second feature points and the map data.

Referring back to FIG. 5, the description will be continued.

On the other hand, in a case where the vehicle 1 stops, a reverse instruction is received by shifting to reverse (R), and the stopping position of the vehicle 1 is determined to be a position at which entry to the planned parking position P1 is permissible, the control unit 11 executes the following processing. In response to determining that a distance between the stopping position and the reversing point TP is equal to or less than the second distance L2, the control unit 11 executes the following processing. In other words, in this case, the vehicle 1 is located at the third position D3, which is equal to or less than the second distance L2 from the reversing point TP.

In the case where a brake pedal (brake operation unit) receives relaxation of braking by the occupant, the control unit 11 starts autonomous traveling along the second route R2.

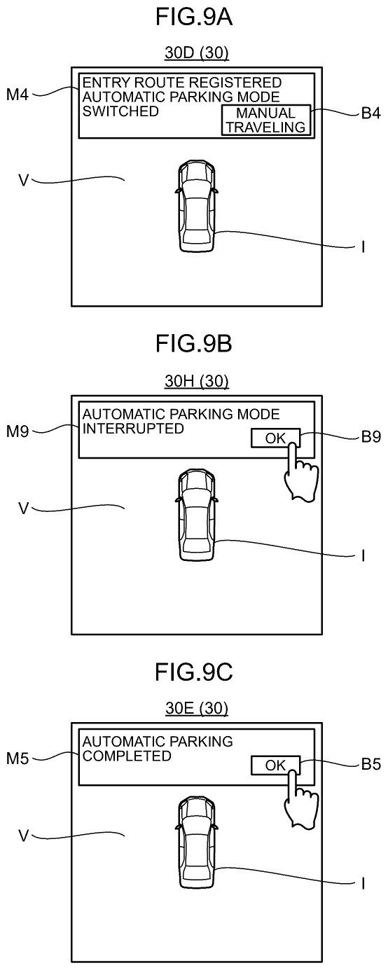

FIG. 9A is a schematic diagram of an example of a display screen 30D. The display screen 30D is an example of the display screen 30 displayed on the display device 22.

The control unit 11 causes the display device 22 to display the display screen 30D including an indication M4 indicating that the teaching route R0 to the planned parking position P1 is registered and that the mode is switched to the autonomous traveling mode, and a button image B4 for the occupant to select switching to manual traveling. In the present embodiment, the control unit 11 causes the display device 22 to display the display screen 30D obtained by superimposing, on the surrounding video V, the indication M4, the button image B4, and the icon image I of the vehicle 1. In FIG. 9A, as an example, the indication M4 is illustrated as wording indicating that the teaching route R0 to the planned parking position P1 is registered and that the mode is switched to the autonomous traveling mode. The indication M4 may be a still image, an animation image, an icon, or the like that indicates that the teaching route R0 to the planned parking position P1 is registered and that the mode is switched to the autonomous traveling mode, and is not limited to wording.

Referring back to FIG. 5, the description will be continued.

In a case where the vehicle 1 performs forward traveling (in the direction of arrow D) in response to an operation on the operation device 20 by the occupant, if the vehicle 1 stops at the third position D3 which is a position within the second distance L2 from the reversing point TP and the second operation is received, the control unit 11 causes the traveling control device 12 to start autonomous backward traveling from the third position D3 to the planned parking position P1 on the basis of the second route R2 from the reversing point TP to the planned parking position P1. As described above, the second operation is an operation in which, by an operation of a shift lever included in the operation device 20 by the occupant, the shift is changed to reverse to receive an instruction to perform backward traveling, and a brake operation unit receives relaxation of braking by the occupant.

Moreover, in a case where a manual-travel start instruction is received, the control unit 11 may interrupt autonomous traveling by canceling the autonomous traveling mode. For example, in a case where the control unit 11 receives an operation instruction by the occupant for the button image B4 (see FIG. 9A) for selecting switching to manual traveling, the control unit 11 receives the manual-travel start instruction and interrupts autonomous traveling.

FIG. 9B is a schematic diagram of an example of a display screen 30H. The display screen 30H is an example of the display screen 30 displayed on the display device 22.

The control unit 11 causes the display device 22 to display the display screen 30H obtained by superimposing, on the surrounding video V, an indication M4 indicating an interruption of autonomous traveling, a button image B9 for receiving an acknowledgment instruction operation for the interruption of autonomous traveling, and an icon image I of the vehicle 1. In FIG. 9B, as an example, the indication M9 is illustrated as wording. Moreover, the indication M9 may be a still image, an animation image, an icon, or the like, and is not limited to wording.

Referring back to FIG. 5, the description will be continued.

If a manual-travel start instruction is not received, the control unit 11 causes the traveling control device 12 to start autonomous backward traveling from the third position D3 to the planned parking position P1 on the basis of the second route R2 from the reversing point TP to the planned parking position P1. Then, in the case where the vehicle 1 enters the planned parking position P1 and autonomous traveling is completed, the control unit 11 causes the display device 22 to display a display indicating completion of parking by autonomous traveling (autonomous parking).

FIG. 9C is a schematic diagram of an example of a display screen 30E. The display screen 30E is an example of the display screen 30 displayed on the display device 22.

The control unit 11 causes the display device 22 to display the display screen 30E including an indication M5 indicating the completion of automatic parking and a button image B5 for receiving a confirmation operation by the occupant. Similar to the foregoing, the display screen 30E is the display screen 30 obtained by superimposing, on the surrounding video V, the icon image I of the vehicle 1, the indication M5, and the button image B5. The indication M5 is information indicating the completion of automatic parking. In FIG. 9C, as an example, the indication M5 is illustrated as wording indicating the completion of automatic parking. Moreover, the indication M5 may be a still image, an animation image, an icon, or the like that indicates the completion of automatic parking, and is not limited to wording.

In response to determining that an operation instruction on the button image B5 is received in response to an operation on the operation device 20 by the occupant, the control unit 11 cancels the autonomous traveling mode and may then cause the vehicle 1 to travel in accordance with operation by the occupant received by the operation device 20.

An example of the procedure of information processing executed by the control unit 11 according to the present embodiment will be described.

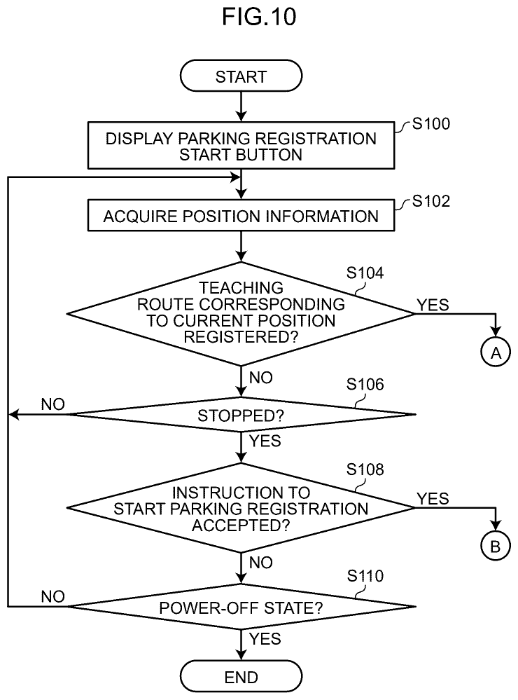

FIGS. 10, 11, and 12 are flowcharts illustrating an example of the procedure of information processing executed by the control unit 11.

The control unit 11 displays a button image for instructing the start of parking registration on the display device 22 of the vehicle 1 during forward traveling, in response to driving by the occupant, i.e., operation of the operation device 20 by the occupant (step S100). As a result of the processing of step S100, for example, the display screen 30A illustrated in FIG. 7A is displayed on the display device 22.

The control unit 11 acquires current position information of the vehicle 1 (step S102). The control unit 11 acquires the current position information of the vehicle 1 by a known method on the basis of the sensor information, the surrounding video V, and the like.

Subsequently, the control unit 11 determines whether the teaching route R0 corresponding to the current position of the vehicle 1 represented by the position information acquired in step S102 is registered in the route management DB 18A (step S104).

For example, the control unit 11 identifies one or more available parking positions from the current position of the vehicle 1 by a known method. The control unit 11 then determines whether teaching route data corresponding to the planned parking position P1 that matches the identified available parking position is registered in the route management DB 18A. This determination processing allows the control unit 11 to determine whether teaching route data for entry to the planned parking position P1 corresponding to the current position information of the vehicle 1 is registered in the route management DB 18A.

In response to determining that the teaching route R0 of the teaching route data corresponding to the current position of the vehicle 1 is not registered (step S104: No), then the process proceeds to step S106.

In step S106, the control unit 11 determines whether the vehicle 1 is stopped (step S106). For example, the control unit 11 performs the determination of step S106 by determining whether a speed included in the sensor information obtained by the sensor 14 reaches zero. If a negative determination is made in step S106 (step S106: No), the process returns to step S102. If an affirmative determination is made in step S106 (step S106: Yes), the process proceeds to step S108.

In step S108, the control unit 11 determines whether an instruction to start parking registration is received (step S108). For example, the control unit 11 performs the determination of step S108 by determining whether a display region of the button image B1 on the display screen 30A illustrated in FIG. 7A, for which display is initiated in step S100, is operated by the occupant.

If a negative determination is made in step S108 (step S108: No), the control unit 11 determines whether the vehicle 1 enters a power-off state (step S110). For example, the control unit 11 may perform the determination by determining whether an operation relating to engine-off is performed in response to an operation on the operation device 20 by the occupant. Alternatively, the control unit 11 may perform the determination by analyzing sensor information and determining whether the vehicle 1 enters a power-off state. If a negative determination is made in step S110 by the control unit 11 (step S110: No), the process returns to step S102. If an affirmative determination is made in step S110 by the control unit 11 (step S110: Yes), this routine is terminated.

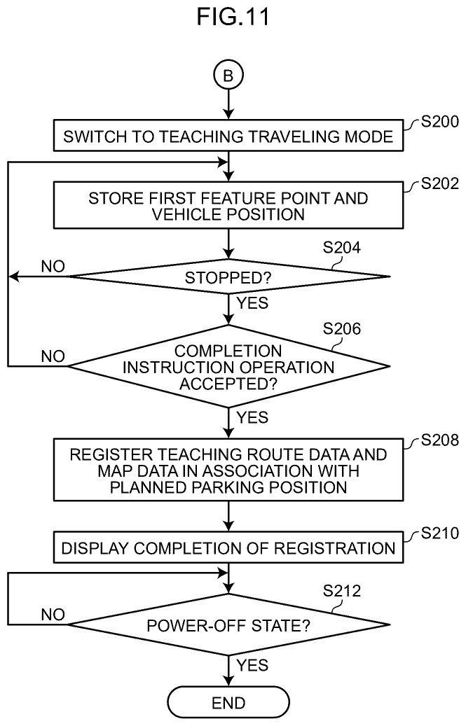

On the other hand, if an affirmative determination is made in step S108 (step S108: Yes), the process proceeds to step S200 in FIG. 11. The case of an affirmative determination in step S108 is a case where the teaching route R0 of the teaching route data corresponding to the current position of the vehicle 1 is not registered, the vehicle 1 is stopped, and an instruction to start parking registration is received.

Description is now given with reference to FIG. 11.

If the teaching route R0 of the teaching route data corresponding to the current position of the vehicle 1 is not registered, the vehicle 1 is stopped, and an instruction to start parking registration is received, the control unit 11 switches the traveling mode to a teaching traveling mode (step S200). As a result of the processing of step S200, the control unit 11 starts processing traveling by the driving operation of the occupant as teaching travel of the vehicle 1.

The control unit 11 sequentially stores a first feature point and a current position of the vehicle 1 in the storage device 18 (step S202). Specifically, the control unit 11 sequentially stores the current positions of the vehicle 1 sequentially estimated along the teaching travel of the vehicle 1. At this event, the control unit 11 assigns an INDEX to the current position and sequentially stores, in association with the INDEX, the traveling position, orientation, traveling direction, and reference traveling information. The control unit 11 also specifies first feature points by performing image analysis on the surrounding video V captured by the camera 16 during the teaching travel and sequentially registers the first feature points in the map data.

Subsequently, the control unit 11 determines whether the vehicle 1 is stopped (step S204). The control unit 11 may perform the determination of step S204 in a similar manner to step S106. If a negative determination is made by the control unit 11 in step S204 (step S204: No), the process returns to step S202. If the control unit 11 determines that the vehicle 1 is stopped (step S204: Yes), the process proceeds to step S206.

The control unit 11 determines whether an operation for instructing completion of the teaching travel is received (step S206). For example, during the teaching travel, the control unit 11 causes the display device 22 to display the display screen 30B including information representing the operation for instructing completion of the teaching travel (see FIG. 7B). The control unit 11 then performs the determination of step S206 by determining whether the operation for instructing completion of the teaching travel is received, the operation including an operation of putting a shift lever into P (parking) after completion of parking or a button operation for switching a shift of the vehicle 1 to parking and an operation of the button image B2 displayed on the display screen 30B. If it is determined, in response to an operation instruction on the operation device 20 by the occupant, that the operation of putting the shift lever into P (parking) or the button operation for switching the shift of the vehicle 1 to parking is performed and that the button image B2 is operated, then the control unit 11 determines that the operation for instructing completion of the teaching travel is received.

If a negative determination is made in step S206 (step S206: No), the process returns to step S202. If an affirmative determination is made in step S206 (step S206:
Yes), the process proceeds to step S208.

In step S208, the control unit 11 registers, in the route management DB 18A, in association with one another, the teaching route data representing a traveling route during the teaching travel represented by a group of current positions sequentially estimated during the teaching travel, as the teaching route R0, the map data in which the first feature points identified during the teaching travel are registered, and the position information of the planned parking position P1 representing the current position of the stopped vehicle 1 (step S208).

Subsequently, the control unit 11 causes the display device 22 to display information indicating the completion of registration of the teaching route R0 (step S210). As a result of the processing of step S210, for example, the display screen 30C illustrated in FIG. 7C is displayed on the display device 22.

Subsequently, the control unit 11 determines whether the vehicle 1 enters a power-off state (step S212). The processing of step S212 is similar to that of step S110. The control unit 11 repeats a negative determination (step S212: No) until an affirmative determination is made in step S212 (step S212: Yes). If an affirmative determination is made in step S212 by the control unit 11 (step S212: Yes), this routine is terminated.

In the present embodiment, by executing the processing of steps S200 to S212, the teaching route data of the teaching route R0, which includes a first route R1 for forward traveling (in the direction of arrow D in FIG. 5) from the first position D1 to the reversing point TP, and a second route R2 for backward traveling from the reversing point TP to the planned parking position P1, is registered in the route management DB 18A (see FIG. 5).

Referring back to FIG. 10, the description will be continued.

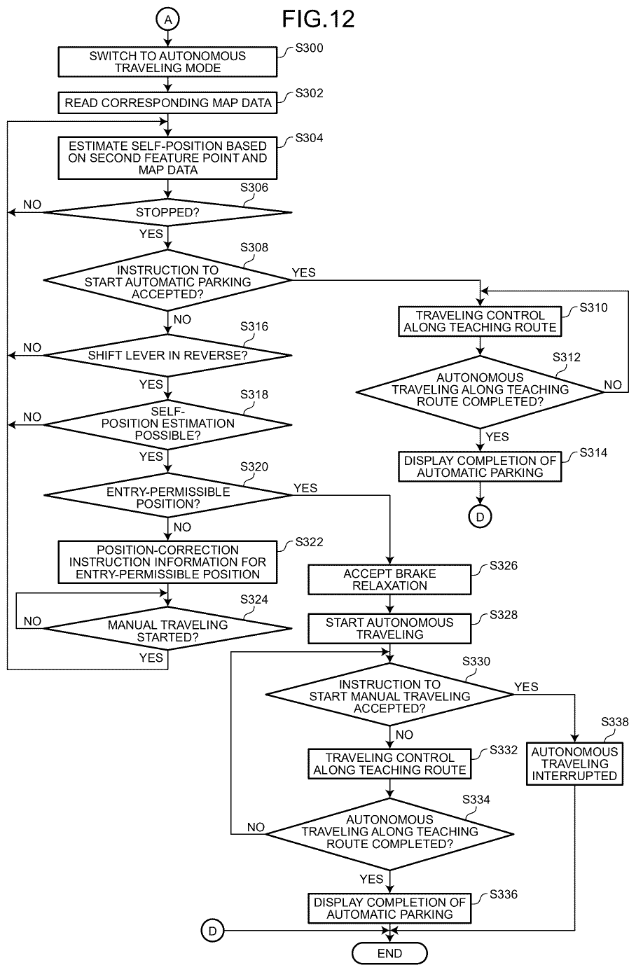

On the other hand, if the control unit 11 determines in step S104 that the teaching route R0 of the teaching route data corresponding to the current position of the vehicle 1 is registered (step S104: Yes), the process proceeds to step S300 in FIG. 12.

Description is now given with reference to FIG. 12.

In a case where the teaching route data corresponding to the current position of the vehicle 1 is registered in the route management DB 18A, the control unit 11 switches the traveling mode to the autonomous traveling mode (step S300). Moreover, at this event, the control unit 11 only switches the traveling mode to the autonomous traveling mode, which is a mode in which autonomous traveling is possible, and traveling by manual driving by the occupant, that is, traveling in response to an operation on the operation device 20 by the occupant, is continued.

The control unit 11 reads, from the route management DB 18A, map data corresponding to the position information of the planned parking position P1 identified for the current position (step S302).

Subsequently, the control unit 11 estimates the self-position, that is, the current position of the vehicle 1 on the basis of the map data read in step S302 and the surrounding video V of the vehicle 1 acquired by at least one camera 16 (step S304).

For example, the control unit 11 matches second feature points identified from the surrounding video V captured by the camera 16 with the first feature points stored in the map data read in step S302 by performing pattern matching, feature descriptor-based search, or the like. The control unit 11 randomly selects several second feature points among the identified second feature points that can be matched with the first feature points stored in the map data. Subsequently, the control unit 11 estimates the current position of the vehicle 1 in the real space on the basis of the positions of these several second feature points in the surrounding video V and the three-dimensional positions in the real space of the first feature points registered in the map data that correspond to the several second feature points. At this event, in detail, as current position information representing the current position of the vehicle 1, the control unit 11 estimates, as the self-position, current position information including a two-dimensional position (X-and Y-coordinates) of the vehicle 1 in the real space and information relating to an attitude, which is an orientation of the vehicle 1.

Subsequently, similar to step S106, the control unit 11 determines whether the vehicle 1 is stopped (step S306). Herein, the stopped state of the vehicle 1 is referred to as stopping. If a negative determination is made in step S306 by the control unit 11 (step S306: No), the process returns to step S304. If an affirmative determination is made in step S306 by the control unit 11 (step S306: Yes), the process proceeds to step S308.

In step S308, the control unit 11 determines whether an instruction to start automatic parking is received (step S308). For example, the occupant issues an operation instruction by operating at least one of a predetermined key, a display region, a display button, and a switch for receiving the instruction to start automatic parking. The control unit 11 performs the determination of step S308 by determining whether the operation instruction is received.

If an affirmative determination is made in step S308 (step S308: Yes), the process proceeds to step S310.

In step S310, the control unit 11 reads, from the route management DB 18A, the teaching route data for the teaching route R0 corresponding to the current position and identified in step S104, and executes traveling control along the teaching route R0 (step S310).

More specifically, if a stopping position at which the vehicle 1 stopped in step S306 is the second position D2 within the first distance L1 with respect to the first route R1 included in the teaching route R0, and if, by an affirmative determination in step S308, a first operation such as reception of an instruction to start automatic parking is received, the control unit 11 executes traveling control along the teaching route R0.

In the traveling control along the teaching route R0 of step S310, the control unit 11 causes the traveling control device 12 to autonomously perform forward traveling of the vehicle 1 from the second position D2 to the reversing point TP on the basis of the first route R1 included in the teaching route R0. Then, the control unit 11 causes the traveling control device 12 to autonomously perform backward traveling of the vehicle control apparatus 10 from the reversing point TP to the planned parking position P1 on the basis of the second route R2 included in the teaching route R0.

Subsequently, the control unit 11 determines whether autonomous traveling along the teaching route R0 is completed (step S312). For example, the control unit 11 performs the determination of step S312 by determining whether the vehicle 1 reaches the planned parking position P1 represented by the teaching route R0. If a negative determination is made in step S312 by the control unit 11 (step S312: No), the process returns to step S310. If an affirmative determination is made in step S312 by the control unit 11 (step S312: Yes), the process proceeds to step S314.

In step S314, the control unit 11 causes the display device 22 to display information indicating the completion of automatic parking (step S314). For example, the display screen 30E illustrated in FIG. 9C is displayed on the display device 22 as a result of the processing of step S314. Then, this routine is terminated.

On the other hand, if a negative determination is made in step S308 (step S308: No), the process proceeds to step S316.

In step S316, the control unit 11 determines whether a shift of the vehicle 1 is shifted to reverse (R), thereby determining whether a reverse instruction is received (step S316). If a negative determination is made by the control unit 11 in step S316 (step S316: No), the process returns to step S304. If an affirmative determination is made by the control unit 11 in step S316 (step S316: Yes), the process proceeds to step S318.

In step S318, the control unit 11 determines whether the self-position of the vehicle 1 is estimated (step S318). For example, the control unit 11 performs the determination in step S318 by determining whether the self-position of the vehicle 1 is estimated by the processing in step S304. If a negative determination is made in step S318 (step S318: No), the process returns to step S304. If an affirmative determination is made in step S318 (step S318: Yes), the process proceeds to step S320.

In step S320, the control unit 11 determines whether the current stopping position of the vehicle 1 is a position at which entry to the planned parking position P1 is permissible (step S320). The control unit 11 reads, from the route management DB 18A, teaching route data of the teaching route R0 corresponding to the current position and identified in step S104. The control unit 11 then determines whether the distance between the reversing point TP, which is an intersection between the first route R1 and the second route R2 included in the teaching route R0 of the teaching route data that has been read, and the stopping position is equal to or less than the second distance L2, thereby determining whether the stopping position of the vehicle 1 is a position at which entry to the planned parking position P1 is permissible.

If the control unit 11 determines that the planned parking position P1 is not an available entry position (step S320: No), the process proceeds to step S322.

In step S322, the control unit 11 causes the display device 22 to display an instruction to correct the position to an entry-permissible position for the planned parking position P1 (step S322).

Description is given with reference to FIG. 5. For example, consider a case where the vehicle 1, perform forward traveling by driving operation of the occupant, stops at a position that is downstream, in the traveling direction along the first route R1 (in the direction of arrow D), of the first position D1 and upstream, in the same traveling direction (on the side of the first position D1), of the reversing point TP of the first route R1. In addition, consider that the stopping position is at a distance greater than the second distance L2 from the reversing point TP. In this case, the control unit 11 determines that the stopping position of the vehicle 1 is a position at which entry to the planned parking position P1 is not permissible.

In this case, through the processing step S322, the control unit 11 causes, for example, the display device 22 to display the display screen 30F illustrated in FIG. 8A.

In other words, in the autonomous traveling mode, if the vehicle 1 stops, by driving operation of the occupant, at a position located, toward the first position D1, apart from the reversing point TP of the first route R1 by at least the second distance L2, and when a reverse instruction is received, for example by shifting a shift of the vehicle 1 to reverse (R), the control unit 11 causes, for example, the display device 22 to display the display screen 30F.

Further, for example, consider a scenario in which the vehicle 1, perform forward traveling by driving operation of the occupant along the first route R1, passes the reversing point TP and then stops after perform forward traveling a distance greater than the second distance L2 from the reversing point TP. In this case as well, the control unit 11 determines that the stopping position of the vehicle 1 is a position at which entry to the planned parking position P1 is not permissible.

In this case, through the processing step S322, the control unit 11 causes, for example, the display device 22 to display the display screen 30G illustrated in FIG. 8B.

In other words, in the autonomous traveling mode, if the vehicle 1 stops, by driving operation of the occupant, at a position located, away from the first position D1, downstream of the reversing point TP of the first route R1 by a distance greater than the second distance L2, and if a reverse instruction is received, for example by shifting a shift of the vehicle 1 to reverse (R), the control unit 11 causes, for example, the display device 22 to display the display screen 30G.

Referring back to FIG. 12, the description will be continued.

Subsequently, the control unit 11 determines whether manual traveling by driving on the basis of an operation on the operation device 20 by the occupant, is initiated (step S324). The control unit 11 repeats a negative determination (step S324: No) until an affirmative determination is made in step S324 (step S324: Yes). If an affirmative determination is made by the control unit 11 in step S324 (step S324: Yes), the process returns to step S304.

On the other hand, if the control unit 11 determines in step S320 that the position is an entry-permissible position (step S320: Yes), the process proceeds to step S326.

In other words, in the case where the vehicle 1 is stopped (step S306: Yes), if a reverse instruction is received by, for example, shifting to reverse (R) (step S316: Yes), and if the control unit 11 determines that the stopping position of the vehicle 1 is a position at which entry to the planned parking position P1 is permissible (step S320: Yes), the process proceeds to step S326. In other words, if, by the processing of step S320, the control unit 11 determines that a distance between the stopping position of the vehicle 1 and the reversing point TP included in the teaching route R0 corresponding to the current position identified in step S104 is equal to or less than the second distance L2, the process proceeds to step S326. In this case, the vehicle 1 is located at the third position D3 within the second distance L2 from the reversing point TP (see FIG. 5).

If a brake pedal (brake operation unit) receives relaxation of braking by the occupant (step S326), the control unit 11 causes the traveling control device 12 to execute autonomous backward traveling along the second route R2 included in the teaching route R0 corresponding to the current position identified in step S104 (step S328).

In other words, if the vehicle 1, perform forward traveling in response to an operation on the operation device 20 by the occupant, stops at the third position D3, which is a position within the second distance L2 from the reversing point TP, and if a second operation is received, the control unit 11 causes the traveling control device 12 to start autonomous backward traveling from the third position D3 to the planned parking position P1 on the basis of the second route R2 from the reversing point TP to the planned parking position P1. As described above, the second operation is an operation in which, by an operation of a shift lever included in the operation device 20 by the occupant, the shift is changed to reverse to receive an instruction to perform backward traveling, and a brake operation unit receives relaxation of braking by the occupant.

Further, in this case, the control unit 11 causes the display device 22 to display the display screen 30D illustrated in FIG. 9A.

The control unit 11 determines whether an instruction to start manual traveling is received (step S330). For example, the control unit 11 performs the determination of step S330 by determining whether an operation instruction by the occupant for the button image B4 for the occupant to select switching to the manual traveling included in the display screen 30D illustrated in FIG. 9A and displayed on the display device 22 is received.

If the control unit 11 determines that an instruction to start manual traveling is not received (step S330: No), the control unit 11 proceeds to step S332. In step S332, the control unit 11 causes the traveling control device 12 to continue executing the autonomous backward traveling along the second route R2 started in step S328 (step S332).

Subsequently, the control unit 11 determines whether autonomous traveling along the teaching route R0, which includes the second route R2, is completed (step S334). For example, the control unit 11 performs the determination of step S334 by determining whether the vehicle 1 reaches the planned parking position P1 represented by the second route R2 included in the teaching route R0. If a negative determination is made in step S334 by the control unit 11 (step S334: No), the process returns to step S330. If an affirmative determination is made in step S334 by the control unit 11 (step S334: Yes), the process proceeds to step S336.

In step S336, the control unit 11 causes the display device 22 to display information indicating the completion of automatic parking (step S336). As a result of the processing of step S336, for example, the display screen 30E illustrated in FIG. 9C is displayed on the display device 22. Then, this routine is terminated.

On the other hand, if an affirmative determination is made in step S330 by the control unit 11 (step S330: Yes), the process proceeds to step S338. In step S338, the control unit 11 causes the traveling control device 12 to interrupt autonomous traveling (step S338). The control unit 11 then causes the display device 22 to display, for example, the display screen 30H illustrated in FIG. 9B. The control unit 11 then terminates this routine.

As described above, the vehicle control method executed by the vehicle control apparatus 10 according to the present embodiment is a vehicle control method executed by a vehicle control apparatus 10 mounted on a vehicle 1 equipped with an operation device 20 that receives operations by an occupant and a traveling control device 12 that controls at least acceleration/deceleration and steering.

The control unit 11 of the vehicle control apparatus 10 registers the teaching route R0 that includes the first route R1 for forward traveling from the first position D1 to the reversing point TP and the second route R2 for backward traveling from the reversing point TP to the planned parking position P1. In the case where the vehicle 1 performs forward traveling in response to an operation on the operation device 20 by the occupant, if the vehicle 1 is positioned at the second position D2 that is within the first distance L1 with respect to the first route R1 and the operation device 20 receives the first operation, the control unit 11 causes the traveling control device 12 to autonomously perform forward traveling from the second position D2 to the reversing point TP on the basis of the first route R1, and then causes the traveling control device 12 to autonomously perform backward traveling of the vehicle 1 from the reversing point TP to the planned parking position P1 on the basis of the second route R2. In addition, in the case where the vehicle 1 performs forward traveling in response to an operation on the operation device 20 by the occupant, if the vehicle 1 is stopped at the third position D3 that is within the second distance L2 from the reversing point TP and the operation device 20 receives the second operation different from the first operation, the control unit 11 causes the traveling control device 12 to autonomously travel backward along the second route R2 from the third position D3 to the planned parking position P1.

Thus, in the vehicle control apparatus 10 and vehicle control method executed by the vehicle control apparatus 10 according to the present embodiment, it is possible to provide sufficient parking assistance in accordance with the position of the vehicle 1 and the operation by the occupant.

Accordingly, the vehicle control apparatus 10 and vehicle control method executed by the vehicle control apparatus 10 according to the present embodiment enable the provision of suitable parking assistance.

The hardware configuration of the vehicle control apparatus 10 according to the present embodiment is now described.

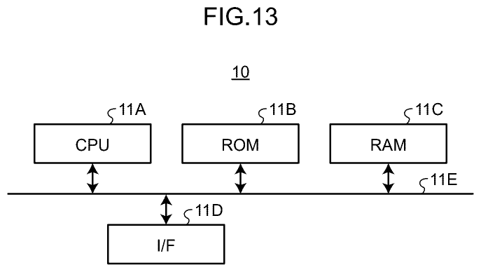

FIG. 13 is a block diagram illustrating an exemplary hardware configuration of the vehicle control apparatus 10.

In the vehicle control apparatus 10, a central processing unit (CPU) 11A, a read-only memory (ROM) 11B, a random-access memory (RAM) 11C, and an I/F 11D for connection to various devices are interconnected by a bus 11E, thereby forming a hardware configuration using an ordinary computer.

The CPU 11A is a computing device that controls overall processing of the vehicle control apparatus 10. The RAM 11C stores data necessary for various processing performed by the CPU 11A. The ROM 11B stores programs and the like for implementing various processing performed by the CPU 11A. The I/F 11D is an interface for connecting to external devices and external terminals via a communication line or the like and for transmitting and receiving data to and from the connected external devices and external terminals.

The programs for executing the various processing described above executed by the vehicle control apparatus 10 are provided pre-installed in the ROM 11B or the like. The program for executing the vehicle control method implemented in the present embodiment may be recorded, in a file of a format installable on or executable by these devices, on a computer-readable recording medium such as a CD-ROM, a flexible disk (FD), a CD-R, or a digital versatile disc (DVD), and provided thereon.

Further, the program for executing the vehicle control method implemented in the present embodiment may be stored on a computer connected to a network such as the Internet and provided by being downloaded via the network. Additionally, the program for executing the vehicle control method implemented in the present embodiment may also be provided or distributed via a network such as the Internet.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A vehicle control method implemented by a vehicle control apparatus provided in a vehicle, the vehicle including an operation device to receive operation by an occupant and a traveling control device to control at least acceleration/deceleration and steering, the vehicle control method comprising:
registering a teaching route including a first route and a second route, the first route being a route for forward traveling of the vehicle from a first position to a reversing point, the second route being a route for backward traveling of the vehicle from the reversing point to a planned parking position;
in a case where the vehicle performs forward traveling in response to operation on the operation device by the occupant, and the vehicle is located at a second position within a first distance with respect to the first route, and the operation device receives a first operation,
causing the traveling control device to autonomously perform forward traveling of the vehicle from the second position to the reversing point based on the first route, and
thereafter causing the traveling control device to autonomously perform backward traveling of the vehicle from the reversing point to the planned parking position based on the second route; and,
in a case where the vehicle performs forward traveling in response to operation on the operation device by the occupant, and the vehicle stops at a third position within a second distance from the reversing point, and the operation device receives a second operation different from the first operation,
causing the traveling control device to autonomously perform backward traveling of the vehicle from the third position to the planned parking position based on the second route.

2. The vehicle control method according to claim 1, wherein
the operation device includes
a forward/reverse operation device configured to receive an instruction to perform forward or backward traveling, and
a brake operation device configured to receive an instruction to perform deceleration of the vehicle, and
the second operation includes
receiving, by the forward/reverse operation device, an instruction to perform backward traveling by the occupant, and
receiving, by the brake operation device, relaxation of braking by the occupant.

3. The vehicle control method according to claim 1, wherein
the operation device includes an automatic parking instruction device configured to receive an instruction to start automatic parking, and
the first operation includes receiving, by the automatic parking instruction device, the instruction to start automatic parking.

4. The vehicle control method according to claim 1, wherein
the operation device includes
a brake operation device configured to receive an instruction to perform deceleration of the vehicle, and
an automatic parking instruction device configured to receive an instruction to start automatic parking, and
the first operation includes
receiving, by the brake operation device, enhancement of braking from the occupant to stop the vehicle, and
receiving, by the automatic parking instruction device, the instruction to start automatic parking.

5. The vehicle control method according to claim 1, wherein the first distance and the second distance are equal to each other.

6. The vehicle control method according to claim 1, further comprising, in a case where the vehicle performs forward traveling in response to operation by the occupant on the operation device, and the second position is within the first distance with respect to the first position that is a part of the first route, and the operation device receives the first operation,
causing the traveling control device to autonomously perform forward traveling of the vehicle from the second position to the reversing point based on the first route, and
thereafter causing the traveling control device to autonomously perform backward traveling of the vehicle from the reversing point to the planned parking position based on the second route.

7. The vehicle control method according to claim 1, wherein
the vehicle further includes a camera to acquire a surrounding video, and
the vehicle control method further comprises
registering the teaching route including the first route and the second route based on the surrounding video acquired by the camera, and
causing the vehicle to autonomously perform forward traveling and/or backward traveling based on the surrounding video acquired by the camera.

8. The vehicle control method according to claim 7, wherein the vehicle control apparatus includes a storage device configured to register the teaching route.

9. The vehicle control method according to claim 1, wherein the first distance of the second position with respect to the first route is equal to a length between an orthogonal intersection and the second position on a straight line that passes through the second position and is orthogonal to the first route, the orthogonal intersection being a point where the straight line and the first route intersect.

10. The vehicle control method according to claim 1, further comprising, in a case where the vehicle performs forward traveling in response to operation on the operation device by the occupant, and the vehicle stops at the third position within the second distance from the reversing point in a predetermined orientation, and the operation device receives the second operation,
causing the traveling control device to autonomously perform backward traveling of the vehicle from the third position to the planned parking position based on the second route.

11. A vehicle control apparatus provided in a vehicle, the vehicle including an operation device to receive operation by an occupant and a traveling control device to control at least acceleration/deceleration and steering, the vehicle control apparatus comprising:
a memory in which a computer program is stored; and
a processor connected to the memory and configured to perform processing by executing the computer program, the processing including
registering a teaching route including a first route and a second route, the first route being a route for forward traveling of the vehicle from a first position to a reversing point, the second route being a route for backward traveling of the vehicle from the reversing point to a planned parking position;
in a case where the vehicle performs forward traveling in response to operation on the operation device by the occupant, and the vehicle is located at a second position within a first distance with respect to the first route, and the operation device receives a first operation,
causing the traveling control device to autonomously perform forward traveling of the vehicle from the second position to the reversing point based on the first route, and
thereafter causing the traveling control device to autonomously perform backward traveling of the vehicle from the reversing point to the planned parking position based on the second route; and,
in a case where the vehicle performs forward traveling in response to operation on the operation device by the occupant, and the vehicle stops at a third position within a second distance from the reversing point, and the operation device receives a second operation different from the first operation,
causing the traveling control device to autonomously perform backward traveling of the vehicle from the third position to the planned parking position based on the second route.

12. The vehicle control apparatus according to claim 11, wherein
the operation device includes
a forward/reverse operation device configured to receive an instruction to perform forward or backward traveling, and
a brake operation device configured to receive an instruction to perform deceleration of the vehicle, and
the second operation includes
receiving, by the forward/reverse operation device, an instruction to perform backward traveling by the occupant, and
receiving, by the brake operation device, relaxation of braking by the occupant.

13. The vehicle control apparatus according to claim 11, wherein
the operation device includes an automatic parking instruction device configured to receive an instruction to start automatic parking, and
the first operation includes receiving, by the automatic parking instruction device, the instruction to start automatic parking.

14. The vehicle control apparatus according to claim 11, wherein
the operation device includes
a brake operation device configured to receive an instruction to perform deceleration of the vehicle, and
an automatic parking instruction device configured to receive an instruction to start automatic parking, and
the first operation includes
receiving, by the brake operation device, enhancement of braking from the occupant to stop the vehicle, and
receiving, by the automatic parking instruction device, the instruction to start automatic parking.

15. The vehicle control apparatus according to claim 11, wherein the first distance and the second distance are equal to each other.

16. The vehicle control apparatus according to claim 11, wherein the processing performed by the processor further includes, in a case where the vehicle performs forward traveling in response to operation by the occupant on the operation device, and the second position is within the first distance with respect to the first position that is a part of the first route, and the operation device receives the first operation,
causing the traveling control device to autonomously perform forward traveling of the vehicle from the second position to the reversing point based on the first route, and
thereafter causing the traveling control device to autonomously perform backward traveling of the vehicle from the reversing point to the planned parking position based on the second route.

17. The vehicle control apparatus according to claim 11, wherein
the vehicle further includes a camera to acquire a surrounding video, and
the processing performed by the processor further includes
registering the teaching route including the first route and the second route based on the surrounding video acquired by the camera, and
causing the vehicle to autonomously perform forward traveling and/or backward traveling based on the surrounding video acquired by the camera.

18. The vehicle control apparatus according to claim 17, further comprising a storage device configured to register the teaching route.

19. The vehicle control apparatus according to claim 11, wherein the first distance of the second position with respect to the first route is equal to a length between an orthogonal intersection and the second position on a straight line that passes through the second position and is orthogonal to the first route, the orthogonal intersection being a point where the straight line and the first route intersect.

20. The vehicle control apparatus according to claim 11, wherein the processing performed by the processor further includes, in a case where the vehicle performs forward traveling in response to operation on the operation device by the occupant, and the vehicle stops at the third position within the second distance from the reversing point in a predetermined orientation, and the operation device receives the second operation,
causing the traveling control device to autonomously perform backward traveling of the vehicle from the third position to the planned parking position based on the second route.
